(19) United States
(12) Patent Application Publication
(10) Pub. No.: US 2008/0092067 A1
(43) Pub. Date: Apr. 17, 2008

(54) Custom properties for automation control

(75) Inventors: Jerome Richard Anderson, Aliso Viejo, CA (US); Robert Christopher Coble, Ladera Ranch, CA (US); Paul W. Forney, Laguna Hills, CA (US); John Joseph Krajewski, Huntington Beach, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 11/645,868

(22) Filed: Dec. 27, 2006

Related U.S. Application Data
(60) Provisional application No. 60/829,600, filed on Oct. 16, 2006.

(51) Int. Cl. G06F 3/048

(52) U.S. Cl. 715/762

(57) ABSTRACT

The present invention provides central management of custom properties, including graphic facets, for an industrial control system. Standards for the custom properties are centrally developed and are then propagated to projects. Even after one or more projects have been developed, the custom property can be centrally changed, and the change can be propagated to all existing projects to override previous properties in the projects. With central management of the graphic, the inner functionality can be abstracted from the location where the graphic will be used. In some embodiments, a custom property is given a default value. That default value may be overridden in a particular project or at particular time, but the property can always revert back to the set default. Some custom properties may be “locked” to prevent user modification, and some properties may be set to be invisible to the end user.

### CROSS-REFERENCE TO RELATED APPLICATION

This application claims priority to U.S. Provisional Patent Application 60/829,600, “Graphics Attributes Support,” which was filed on Oct. 16, 2006, and which is incorporated herein by reference in its entirety.

### FIELD OF THE INVENTION

The present invention relates generally to computer software for automation control, and, more particularly, to customizing automation control objects.

### BACKGROUND OF THE INVENTION

Industry increasingly depends upon highly automated data-acquisition and control systems to ensure that industrial processes run efficiently and reliably while lowering overall production costs. Data acquisition begins when sensors measure aspects of an industrial process and report their measurements back to a data-collection and control system. Such measurements could include, for example, temperature, pressure, pH, mass or volume flow of a material, count of items passing through a particular machine or process, and tallied inventory of packages waiting in a shipping line. Sophisticated process-management software examines the incoming measurements, produces status reports and operation summaries, and, in many cases, responds to events and operator instructions by sending commands to controllers that modify operation of at least a portion of the industrial process. These systems of sensors, controllers, and process-management software together allow operators to perform a number of supervisory tasks including tailoring the process in response to varying external conditions, detecting an inefficient or non-optimal operating condition or impending equipment failure, and taking remedial action such as moving equipment into and out of service.

To allow human operators to keep up with a sophisticated industrial process, human-machine interface (“HMI”) systems are linked to the data sources, digest their data measurements, and in turn drive visualization applications that render graphical views of the industrial process for the operators. A typical HMI includes a set of graphical views of the industrial process and of its physical output. Each view, in turn, includes one or more graphical elements. Some graphical elements are “animated” in that their display state changes in response to changes in the incoming data measurements. For example, an HMI for a refining process could include a visual depiction of a storage tank. The tank's depiction includes an indicator showing the level of liquid contained in the tank, and the visual indicator rises and falls in response to measurements from a sensor that measures the level of liquid in the actual tank. This type of animation has been found to be considerably easier for a human observer to comprehend than a simple stream of measurements. Graphical images provided by HMI applications are also used to depict, and to facilitate modifying, current process set points.

Typically, the physical sensors and controllers of the industrial process are linked to the HMI by a set of software modeling elements called automation objects. A traditional automation object could include several “facets” such as variables, scripts, alarm behavior, and history behavior. An application engine provides the computer processing to support these facets. When graphic facets are added to automation objects, they require a new type of engine called a “view engine.” Unlike the previous facets (for ease of the present discussion, these are collectively called “data facets”), graphic facets are not assigned to a single engine for execution. Instead, graphic facets can be executed on many view engines simultaneously. Take for example, an automation object that represents a motor. The graphic facet of this motor may include several graphics such as an animated visual representation of the motor, a faceplate used to operate the motor, and a maintenance screen used to track service records for the motor. Several HMI workstations in the industrial plant could simultaneously display different graphics of the motor. For safety's sake, some facilities require that operators have a direct line of sight to equipment in order to operate that equipment. Therefore, an HMI workstation placed next to the motor could display the faceplate used to operate the motor in a manner different from the display of an HMI workstation remote from the motor.

### BRIEF SUMMARY OF THE INVENTION

In view of the foregoing, the present invention provides central management of custom properties, including graphic facets, for an industrial control system. Standards for the custom properties are centrally developed and are then propagated to projects. Even after one or more projects have been developed, the custom property can be centrally changed, and the change can be propagated to all existing projects to override previous properties in the projects.

Standards can be created in a graphic toolbox before they are shared across multiple templates. For example, a user can once create a graphic to display analog data and then use that graphic in multiple templates that require the exposure of analog data. With central management of the graphic, the inner functionality can be abstracted from the location where the graphic will be used. The functionality of a graphic is defined by animations and scripts for the graphic. Custom properties expose this functionality without forcing a user to redefine the functionality each time the graphic is used.

In some embodiments, a custom property is given a default value. That default value may be overridden in a particular project or at particular time, but the property can always revert back to the set default. Some custom properties may be “locked” to prevent user modification, and some properties may be set to be invisible to the end user.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a screen shot of an exemplary visual editor that can be used to develop custom properties according to the present invention;

FIGS. 2a, 2b, and 2c are data structure diagrams that illustrate how custom properties can be embedded at different levels within symbols;

FIG. 3 is a table that shows how an embedded lock changes when its base lock is changed;

FIG. 4 is a flowchart showing how a custom property can revert to its default value; and

FIG. 5 is a table showing how an embedded protection changes when its base protection is changed.

### DETAILED DESCRIPTION OF THE INVENTION

Turning to the drawings, wherein like reference numerals refer to like elements, the present invention is illustrated as being implemented in a suitable environment. The following description is based on embodiments of the invention and should not be taken as limiting the invention with regard to alternative embodiments that are not explicitly described herein.

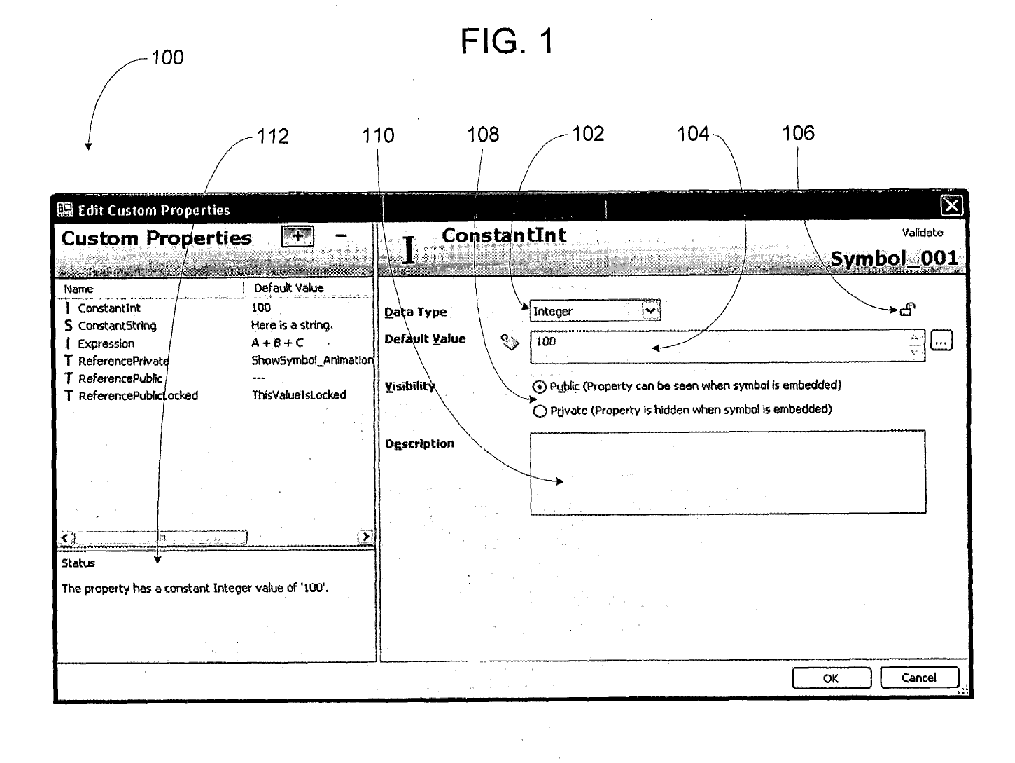

FIG. 1 shows an exemplary screen 100 for creating and for editing custom properties. In general, the editor shows the data type 102 of a custom property, the property's default value 104 (which can be a multi-line expression), whether or not the property's default value is locked 106, whether or not the property is to be made visible to an end user 108, and a description of the property 110. These aspects of the custom property are discussed in greater detail throughout the remainder of this document.

Each non-locked property in each instance of a graphic can have its own non-default value. For example, an embedded symbol has a custom property used to hold a text value. There may be more than one use of this symbol on a single window, and each use can have a different, non-default text value.

When a user of the editor shown in FIG. 1 assigns a default value, the default value is compiled immediately to determine if the default value is one of these three types: expression, reference, and constant. The user is notified of the type in the status area 112 of the editor screen 100.

If the default value is an expression, then the user assigns a data type 102 to it. When the expression is evaluated at runtime, the result of the expression is converted to the assigned data type. Supported data types for custom properties could include, for example, boolean, double, elapsed time, enumeration, float, integer, internationalized string, string, time, and an array of values.

If the default value is a reference, then when the reference is accessed at runtime, the data type used is the data type the reference points to.

If the default value is a constant, then the user can assign a data type 102. When a constant is evaluated at runtime, the result is converted into the assigned data type.

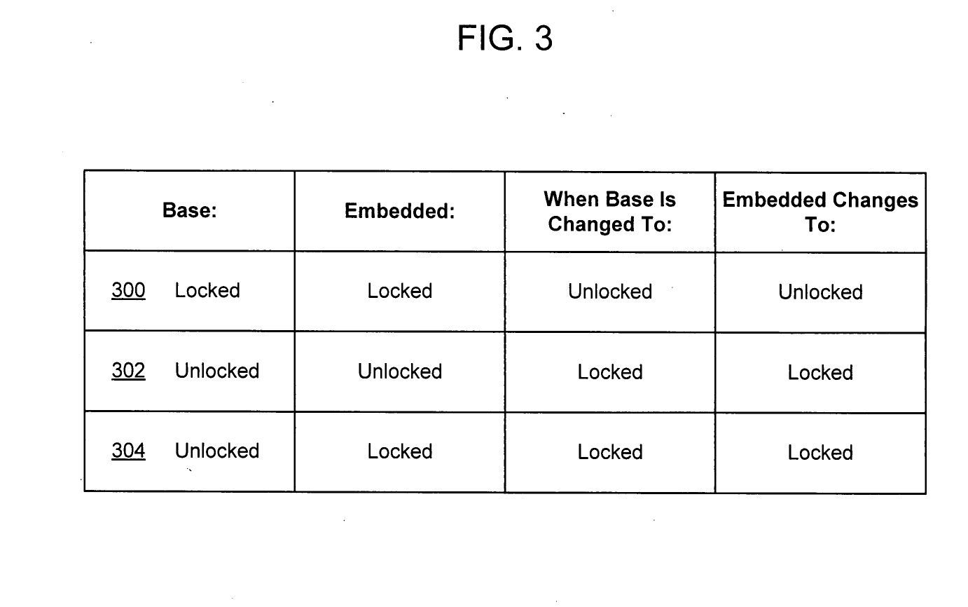

Each custom property is configured with a default value (104 in FIG. 1). For reference default values, a valid placeholder such as “---” may be used and will not result in a configuration error. If the user wishes, this default value can be locked against change 106. In that case, the default value may not be overridden at runtime, and changes made to the symbol master propagate to the embedded symbol whenever the embedded symbol is next opened, on the next deploy, for example. FIG. 3 and its accompanying text describe how changes to the lock can be propagated.

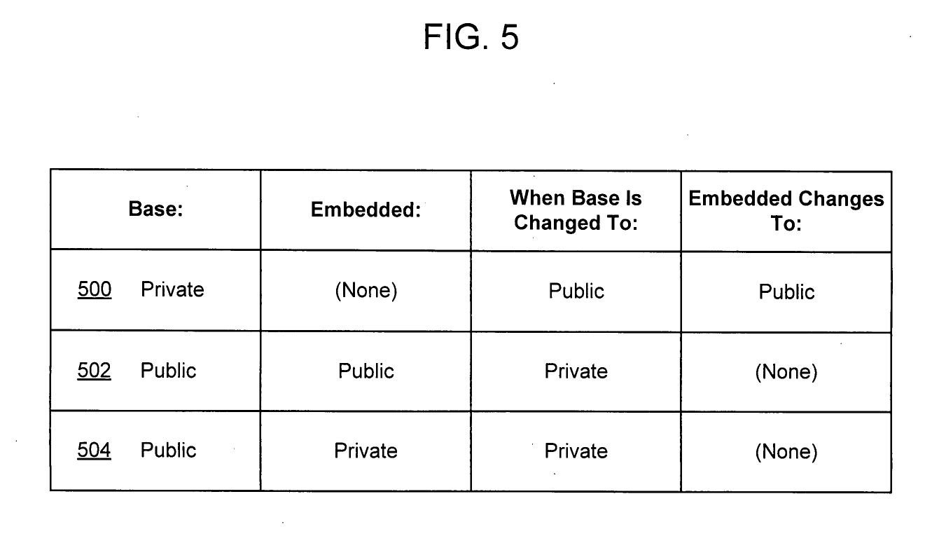

End users may or may not need to use a given custom property. For example, an end user would not need to use a custom property that serves only as an internal variable for a calculation. The graphic developer can “hide” these internal variables using the visibility scope setting 108. “Public” custom properties are exposed to users when they embed the symbol. “Private” custom properties are not exposed. FIG. 5 and its accompanying text describe how changes to the visibility scope setting are propagated.

The persistence of the custom property can be set. A “non-retentive” property is initialized to its default value on start-up. On the other hand, a non-default value of a “retentive” custom property is written to disk with all other check-pointed data during runtime. At start-up, the last data stored on disk are retrieved and used to initialize the custom property.

In the Description text field 110, the graphic developer can provide usage instructions to the end user who eventually embeds the graphic.

The end user can override most aspects of the custom property if the custom property is not locked in the parent. If the default value is overridden, then the type (expression, reference, or constant) of the new non-default value supplants the pre-existing type. While the default values of individual array elements can be overridden, in some implementations the length of the array cannot be changed. The visibility scope can be overridden from Public to Private, but not from Private to Public. The description can be overridden, and locked state can be overridden from unlocked to locked, but not from locked to unlocked. The user cannot override the data type.

A string property has both a value and a “String Mode.” The String Mode is set either to “Constant String,” wherein the value itself is a string (like “Tank 1”), or to “Reference to String,” wherein the value refers to a string. Both the default value and the String Mode can be overridden. For example, a symbol developer creates a property with a String Mode set to Constant String and a default value of “Enter Tank Name Here.” The end user resets the String Mode to Reference to String and overrides the default value so that it now points to a string containing the actual tank name.

The data in custom properties are specific to a currently visible graphic and are not accessible outside of the running display. For example, if an object is running on an application engine and has a script running, then that script will not have direct access to the custom properties.

A custom property is given preference in reference-binding resolution. This means that if a custom property and a valid reference (such as object name) collide, then the custom property is bound.

If an expression is re-evaluated, then anything that refers to it is notified. If a custom property is of a reference type, then the custom property is notified if the referent changes. The custom property notifies anything that refers to it of the change. If a constant changes, then the custom property notifies anything that refers to it of the change.

In an animation, an expression-type custom property is evaluated in the same manner as other expressions. A change to any member of the expression triggers a re-evaluation of the expression. An animation cannot write to an expression-type custom property, and such an attempt will generate a runtime error. An animation can read an expression-type property. If the custom property is updated due to a change of a reference in the expression, then the custom property in turn causes a re-evaluation of any expressions which reference it.

In an animation, a reference-type custom property is treated as a pass-through for all functionality. An animation can write to a reference-type custom property. Instead of writing the data to the custom property, the data are forwarded to the custom property's referent. If the referent changes, then the custom property in turn notifies any expressions that use it of the change. An animation can use a reference-type custom property for reading data. The data that are read do not come from the custom property itself but rather come from the referent of the custom property.

An animation can write data directly to a constant-type custom property. If the custom property changes, then any expressions that use it are notified. If the custom property was locked at configuration time, then the write is not allowed. An animation can read data directly from a constant-type custom property.

For the most part, a script treats custom properties in the same manner as does an animation. When running a script, a user cannot change an expression or read the expression definition itself (the data resulting from the evaluation can be read). Similarly, a user cannot change a reference or read the reference definition at runtime but can read the referent data of the reference. A script can read from and write to a constant-type custom property.

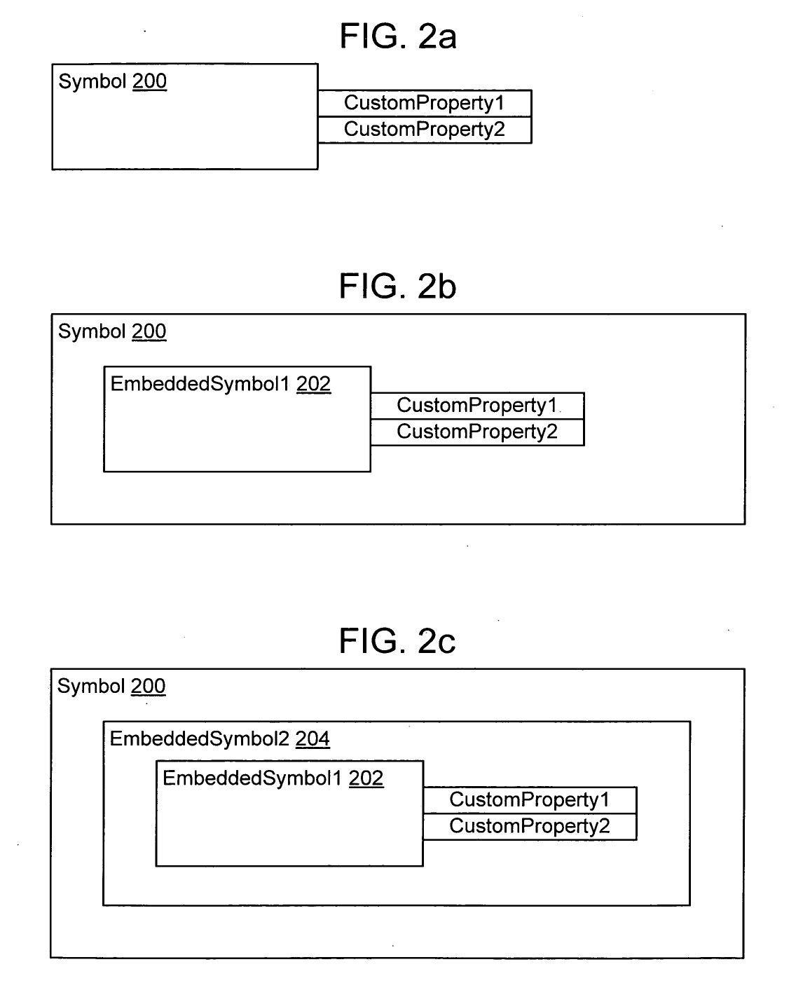

FIGS. 2a, 2b, and 2c show different scenarios for embedding custom properties. In FIG. 2a, the custom properties are located on the host and can be referenced directly as:

CustomProperty1

CustomProperty2

In FIG. 2b, the custom properties are directly embedded in a symbol 202. Reference to the custom properties requires the name of the symbol name and a delimiter (dot):

EmbeddedSymbol1.CustomProperty1

EmbeddedSymbol1.CustomProperty2

In FIG. 2c, the custom properties are indirectly embedded. Here, reference to the custom properties requires the names of all of the symbols in the order of the embedding and a delimiter:

EmbeddedSymbol2.EmbeddedSymbol1.CustomProperty1

EmbeddedSymbol2.EmbeddedSymbol1.CustomProperty2

FIG. 3 shows how an embedded lock changes when its base lock is changed. In the scenario of row 300, the base is Locked, and the user is not allowed to change that setting. Thus, when the base is changed to Unlocked, that change is propagated to the embedded lock. In the scenario of row 302, the base is changed from Unlocked to Locked. The user was allowed to change the embedded lock but did not do so, so the change to the base propagates to the embedded lock. The scenario of row 304 is similar to that of row 302, but here the user chose to override the lock. The overridden lock is the same as the new base (Locked), so the embedded lock is not changed. However, in scenarios 302 and 304 the embedded lock is not overridden and can no longer be changed by the user. If a custom property becomes locked, then all overrides on that property are discarded.

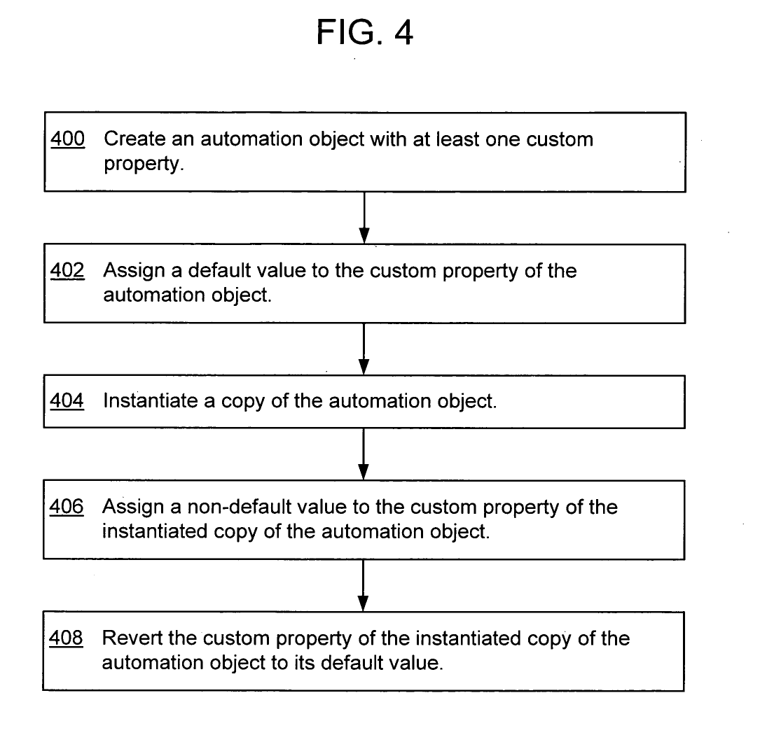

FIG. 4 puts together the information given above about default values. In step 400, a custom property is created (possibly by means of an editor like that illustrated in FIG. 1). A default value is assigned to the property in step 402 (see 104 in FIG. 1). In step 404, an instance of the automation object is created. An end user assigns a non-default value to the custom property of the instantiated object in step 406. In step 408, the custom property of the instantiated object reverts to its default value. For example, if the custom property is non-retentive, step 408 may occur during start-up.

FIG. 5 shows how the protection of an embedded custom property changes when its base protection is changed. In the scenario of row 500, the base protection changes from Private to Public. The user is not allowed to override (indeed, cannot even see) a Private property, so the change to the base protection is now displayed in the embedded protection. Because the user cannot see a Private property, FIG. 5 shows the embedded protection as “(None).” In the scenario of row 502, the base protection is Public, and the user has not chosen to override it. When the base protection changes to Private, the change propagates to the embedded protection. In the scenario of row 504, the base protection again begins as Public, but the user has chosen to override it. When the base protection changes, it changes to the protection already chosen by the user. In scenarios 502 and 504, the base protection has become Private, so the user can no longer override (or see) it. If a custom property becomes invisible, then all overrides on that property are discarded.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

We claim:

1. In an automation control environment, a method for customizing an automation object comprising a graphic facet, the method comprising:
creating an automation object with at least one graphic facet, the graphic facet comprising a property;
assigning a default value to the property of the graphic facet;
instantiating a copy of the automation object;
assigning a non-default value to the property of the graphic facet of the instantiated copy of the automation object; and
reverting the property of the graphic facet of the instantiated copy of the automation object to its default value.

2. The method for customizing an automation object of claim 1 wherein the graphic facet comprises multiple graphics.

3. The method for customizing an automation object of claim 1 wherein the automation object further comprises at least one data facet.

4. The method for customizing an automation object of claim 1 wherein creating the automation object comprises creating an automation object template.

5. The method for customizing an automation object of claim 1 further comprising:
indicating whether or not the property of the graphic facet may be visible to an end user.

6. The method for customizing an automation object of claim 1 further comprising:
indicating whether or not a value of the property of the graphic facet may be changed by an end user.

7. The method for customizing an automation object of claim 1 wherein reverting the property of the graphic facet of the instantiated copy of the automation object to its default value occurs during start-up.

8. The method for customizing an automation object of claim 1 further comprising:
providing instructions to an end user on how to assign a non-default value to the property of the graphic facet.

9. A computer-readable medium containing computer-executable instructions for a method for customizing an automation object comprising a graphic facet, the method comprising:
creating an automation object with at least one graphic facet, the graphic facet comprising a property;
assigning a default value to the property of the graphic facet;
instantiating a copy of the automation object;
assigning a non-default value to the property of the graphic facet of the instantiated copy of the automation object; and
reverting the property of the graphic facet of the instantiated copy of the automation object to its default value.

10. A computer-readable medium containing a computer-readable automation object, the automation object comprising:
at least one graphic facet, the graphic facet comprising at least one property;
a pointer to a default value for the property of the graphic facet; and
a non-default value for the property of the graphic facet.

11. The computer-readable medium of claim 10 wherein the computer-readable automation object further comprises:
a data facet.

12. The computer-readable medium of claim 10 wherein the computer-readable automation object further comprises:
an indication as to whether or not the property of the graphic facet may be visible to an end user.

13. The computer-readable medium of claim 10 wherein the computer-readable automation object further comprises:
an indication as to whether or not a value of the property of the graphic facet may be changed by an end user.

14. The computer-readable medium of claim 10 wherein the computer-readable automation object further comprises:
instructions for an end user on how to assign a non-default value to the property of the graphic facet.

15. In an automation control environment, a method for allowing multiple end users to customize automation objects comprising graphic facets, the method comprising:
creating an automation object with at least one graphic facet, the graphic facet comprising a property;
assigning a default value to the property of the graphic facet;
instantiating a first copy of the automation object;
instantiating a second copy of the automation object;
assigning by a first end user a first non-default value to the property of the graphic facet of the first instantiated copy of the automation object;
assigning by a second end user a second non-default value to the property of the graphic facet of the second instantiated copy of the automation object; and
reverting the property of the graphic facet of the first and second instantiated copies of the automation object to its default value.

16. The method for allowing multiple end users to customize automation objects of claim 15 wherein creating an automation object comprises creating an automation object template.

17. A computer-readable medium containing computer-executable instructions for a method for allowing multiple end users to customize automation objects comprising graphic facets, the method comprising:
creating an automation object with at least one graphic facet, the graphic facet comprising a property;
assigning a default value to the property of the graphic facet;
instantiating a first copy of the automation object;
instantiating a second copy of the automation object;
assigning by a first end user a first non-default value to the property of the graphic facet of the first instantiated copy of the automation object;
assigning by a second end user a second non-default value to the property of the graphic facet of the second instantiated copy of the automation object; and
reverting the property of the graphic facet of the first and second instantiated copies of the automation object to its default value.

18. In an automation control environment, a system for monitoring automation objects in the control environment, the system comprising:
an automation object library, the automation object library comprising an automation object template, the automation object template comprising a graphic facet, the graphic facet comprising a property and a default value for the property; and
first and a second instantiations of the automation object template;
wherein the first instantiation of the automation object template comprises a first non-default value of the property and a link to the default value of the property; and
wherein the second instantiation of the automation object template comprises a second non-default value of the property and a link to the default value of the property.

19. The system for monitoring automation objects of claim 18 wherein the graphic facet comprises multiple graphics.

20. The system for monitoring automation objects of claim 18 wherein the automation object template further comprises:
at least one data facet.

21. The system for monitoring automation objects of claim 18 wherein the automation object template further comprises:
instructions for an end user on how to assign a non-default value to the property of the graphic facet.

22. The system for monitoring automation objects of claim 18 wherein the graphic facet further comprises:
a second property; and
a second default value for the second property.

23. The system for monitoring automation objects of claim 22 wherein the automation object template further comprises:
an indication as to whether or not the second property of the graphic facet may be visible to an end user.

24. The system for monitoring automation objects of claim 22 wherein the automation object template further comprises:
an indication as to whether or not a value of the second property of the graphic facet may be changed by an end user.
